(19) United States
(12) Patent Application Publication
(10) Pub. No.: US 2026/0312862 A1
(43) Pub. Date: Oct. 8, 2026

(54) METHOD AND SYSTEM FOR MANAGING FEATURES FOR OPTIMAL MODEL PERFORMANCE AND APPLICATION THEREOF

(71) Applicant: Verizon Patent and Licensing Inc., Basking Ridge, NJ (US)

(72) Inventor: Varun Unnikrishnannair, Bangalore (IN)

(73) Assignee: Verizon Patent and Licensing Inc., Basking Ridge, NJ (US)

(21) Appl. No.: 19/170,479

(22) Filed: Apr. 4, 2025

(51) Int. Cl. H04L 41/0631; H04L 41/085; H04L 41/16

(52) U.S. Cl. CPC H04L 41/0631; H04L 41/085; H04L 41/16

(57) ABSTRACT

The present teaching relates to manage data features for machine learning a prediction model. Based on event sequence data, features are extracted and feature segments are created. Critical signals are generated based on specified targets to be predicted that representing the operation of a network. Target-based weights on respective feature segments are determined based on historical data representing past operation states of the network and are used to encode the feature segments. The encoded feature segments are used to generate target-based optimal training data, which is used to train models for predicting the specified targets based on real0time network data.

### BACKGROUND

Data characterizing the operational states of services/products via digital channels may be analyzed to facilitate management thereof to ensure to the services meet the intended purposes. For example, in managing the operation of a network, digital information representing the operational states of various network components and connections thereof may be analyzed to monitor the health of the network. Information recording the network operations may be utilized to train models for predicting, e.g., anomalies in the network operation so that measures may be preemptively deployed to prevent failures.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary framework for obtaining optimal models via managing features based on specified targets, in accordance with an embodiment of the present teaching;

FIG. 2A depicts an exemplary application of obtaining optimal prediction models via feature management based on specified targets, in accordance with an embodiment of the present teaching;

FIG. 2B illustrates data collection windows of different sizes which may be dynamically adjusted in optimally managing features based on targets, in accordance with an embodiment of the present teaching;

FIG. 2C is a flowchart of an exemplary application of obtaining optimal prediction models for predicting specified targets via target-based feature management, in accordance with an embodiment of the present teaching;

FIG. 3A depicts an exemplary high-level system diagram of a target-based feature manager, in accordance with an embodiment of the present teaching;

FIG. 3B illustrates exemplary types of feature segmentation models that may be used to classify different types of features;

FIG. 3C is a flowchart of a target-based feature manager, in accordance with an embodiment of the present teaching;

FIG. 4A illustrates event sequence windows of different sizes which may be dynamically determined in optimally managing features based on targets, in accordance with an embodiment of the present teaching;

FIG. 4B shows an exemplary application of the present teaching in network management to determine relevance of features with respect to specified targets, in accordance with an embodiment of the present teaching;

FIG. 5 is an illustrative diagram of an exemplary mobile device architecture that may be used to realize a specialized system implementing the present teaching in accordance with various embodiments; and

FIG. 6 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

Pattern recognition techniques have been used to understand implicated relationships in data and provide guidance to business operations. For example, in the telecommunication industry, network operations may be managed by, e.g., recognizing patterns of network behavior prior to malfunction and predicting potential failures based on the recognized patterns so that preemptive measures may be put in place to counteract. Pattern recognition is performed based on features extracted from data. For example, when applied in network management applications, network operational data may be continuously collected which may be computed to extract different features to characterize the performance in different aspects of the network operation, including, e.g., the network resource usage statistics, the bandwidth capacity of different towers in a wireless network, or the percent of call drops in each service region of the network, etc. Such features may be relied on to detect the patterns of data prior to, e.g., network malfunction. Models are developed to incorporate knowledge about intricate relationships between features and the target patterns. Such models can be trained, via machine learning, to learn knowledge from training data, which generally includes mappings from data features to targets representing the domain knowledge needed to perform pattern recognition. Given a trained model with such learned knowledge, when the model is given data features, the model can map from the input data features to target patterns. Depending on the training data, some features may attribute more to the prediction, and some may attribute less, or not at all. Determining which features impact more to the prediction is critically important and has a direct consequence on the performance of the models.

The performance of a model depends on the quality of the training data. As training data generally includes mappings from data features to targets and the quality of the mappings may be assessed based on, e.g., whether the features are appropriately attributing or relevant to the targets. Poorly managed features can lead to problems. For instance, when too many features are included in the training, it is resource intensive to collect a wide range of data and computationally expensive to determine the features and training the models. Including those features that do not reasonably attribute to the target patterns can cause under fitting of the model and fail to capture the true relationship between features and the targets. When there are too few features with inadequate representation power, this can also lead to under fitting. In some situations, with too many relevant features, it may lead to overfitting, yielding models without any flexibility that result in poor bandwidth management, capacity planning predictions or the like. Thus, poor feature management prevents models from capturing the essence of the data, producing over or under learned models leading to model imprecision and degradation. Another issue is that in many applications, targets may change dynamically over time. Traditionally, feature management is often done manually by human. Even when some analytical process may be developed to select relevant features with respect to given targets, such a separate process is semi-manual and is not practical, particularly in applications where targets change over time.

The present teaching discloses a framework to optimize capacity planning and/or network bandwidth management by optimizing models via machine learning using training data created via optimal feature management. In the optimal feature management scheme, features are segmented into different groups, each of which includes features that behave in a similar manner, so that features in the same group may be assessed together in terms of the relevance to each of a set of specified targets. Each of the targets may be specified associated with the task in an application and may be represented as a critical signal. Between each group of features and each of the targets (i.e., critical signals), the relevance score or a weight may be automatically determined based on, e.g., historical information in the same domain. Such automatically determined weights represent the domain specific expertise determined from relevant cumulated experience. Each weight associated with a group of features indicates a level of attribution of the group of features to each of the targets. The lower the attribution, the lower the relevance to the target. The higher the attribution, the higher the relevance to the target.

Based on such automated and dynamic evaluation of relevance of each group of features to each of the targets, an optimal set of training data may be generated for training, via machine learning, models for carrying out tasks (e.g., classification, prediction, etc.) with respect to the given targets. As the optimal training data set includes features selected based on relevance evaluation, it enables the models to learn, during the training, the knowledge about the relevant relationships between data and the targets to enhance both the training and the model performance. This feature management process is adaptive to specified targets, it is generic with respect to any application. The automated feature management process serves to automatically identify those data features that are not relevant to the current targets so that while data may be collected to meet the requirements of a broad range of applications, it supports different applications with different targets without sacrificing the quality of models obtained by utilizing the collected data.

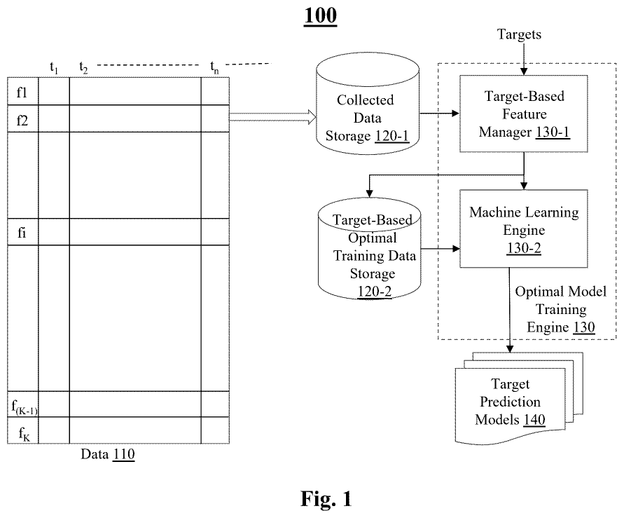

FIG. 1 depicts an exemplary framework 100 for obtaining target prediction models 140 based on target-based optimal training data created via a feature management process, in accordance with an embodiment of the present teaching. In this framework 100, data 110 is collected from an application as, e.g., an event sequence at different time instants t₁-tₙ, each of which may be used to extract a plurality of features f₁-fₖ. The framework 100 includes an optimal model training engine 130 which comprises a target-based feature manager 130-1 for creating target-based optimal training data as well as a machine learning engine 130-2 for deriving, via machine learning, the target prediction models 140 based on target-based optimal training data. The collected data 110 is stored in a collected data storage 120-1, which is used by the target-based feature manager 130-1 as input to create, via feature management based on some targets specified in connection with an application, target-based optimal training data, which is then stored in a target-based optimal training data storage 120-2. Such optimal training data is generated based on the collected data with respect to the input targets so that the training data included in the optimal training data is relevant and attributing to the specified targets. The target-based optimal training data is then used by the machine learning engine 130-2 to train the target prediction models 140.

The underlying application of framework 100 may be any application and an input target may be associated with any aspect of the application. For example, an application may be for network management provided for managing the operation of a network. In this example, the network management application may aim at managing some aspects of the network operation, including, e.g., resource allocation to different network components based on predicted need for each component, network failure prevention based on predicted malfunction with respect to key components, network traffic management based on predicted traffic patterns, etc. In this case, the targets to be predicted include a need for network resource at each node, a likelihood of malfunction of each key component in the network, and the traffic pattern with respect to different components at different times. With respect to these specified targets, the data 110 collected may include data/features that may not be relevant to any of these targets. For instance, the collected data 110 may include network maintenance information and such data/features may not attribute to the targets specified. In this case, data/features not relevant to the specified targets may be recognized as such and will not be included in the target-based optimal training data so that the target prediction models 140 may be trained to learn the knowledge useful to capture the meaningful data-target mapping relations.

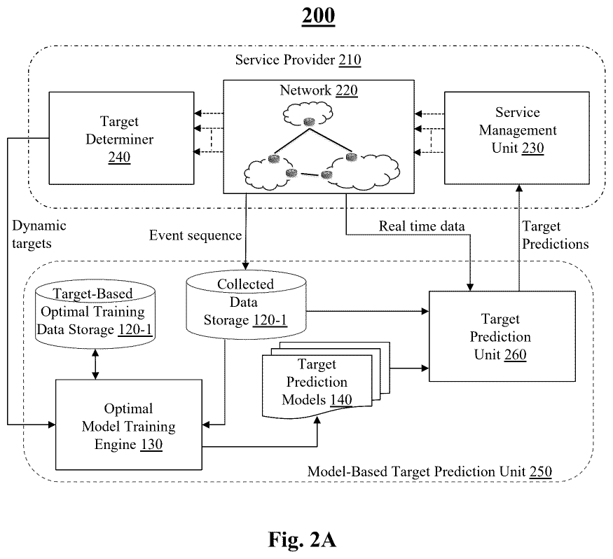

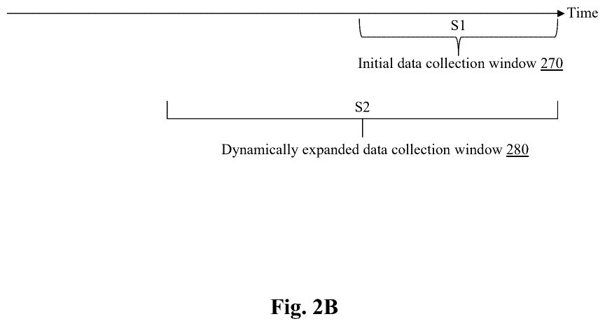

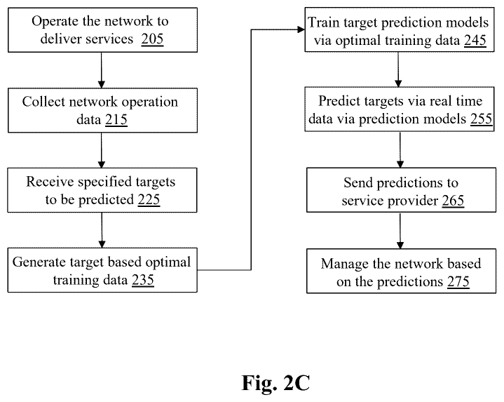

FIG. 2A depicts an exemplary application environment 200 for network management to obtain optimal prediction models via feature management based on targets specified in connection with the application, in accordance with an embodiment of the present teaching. In this illustration, the environment 200 includes a service provider 210 and a model-based target prediction unit 250. In some embodiments, the service provider 210 may correspond to a wireless communication service provider which may include a network 220, through which wireless services are delivered to customers, a service management unit 230 for managing different aspects of the network to ensure performance, and a target determiner 240 for determining different target aspects of the network 220 that need to be managed. Depending on the network operation, target aspects to be managed may change over time. For instance, during a holiday season, the aspect of network traffic may be emphasized to ensure smooth operation. Prior to a winter season with snowstorms, the tower maintenance may be a target aspect for network management and this target may differ from that in a summer season in the same service region. The dynamically determined targets are provided to the model-based target prediction unit 250, which predicts targeted aspects and provide the predictions to the service management unit 230, which manages the network 220 according to the received predictions.

As can be seen in FIG. 2A, the model-based target prediction unit 250 is provided for making predictions of some specified target aspects of the network operation based on real-time collected network operation data (event sequence) in accordance with target prediction models obtained with respect to the specified dynamic targets. In this illustrated embodiment, the feature management mechanism as depicted in FIG. 1 (including 120, 130, and 140) is deployed in the model-based target prediction unit 250 to derive target prediction models 140 based on target-based optimal training data (in 120-2) created in accordance with the dynamic targets. As shown, data associated with a sequence of events occurred during the operation of the network 220 may be collected and stored in collected data storage 120-1. As discussed herein with reference to FIG. 1, the optimal model training engine 130 utilizes the collected data in 120-1 to create the target-based optimal training data (in 120-2) and train the target prediction models 140 using the optimal training data. Such optimally obtained target prediction models 140 may then be used by a target prediction unit 260 to produce predictions of targets as specified by the target determiner 240.

In some embodiments, the event sequence collected from the network operation may be conducted using some collection parameters, including an event sequence window which may cover a period such as one day, one week, etc. In some embodiments, such data collection parameters may be dynamically adjusted to facilitate the feature management. For instance, a default window size for collecting event sequence may be one day. A default data collection window size may not be appropriate for some targets. For instance, if a target to be predicted is whether issues exist in international charge in wireless services outside of the U.S., a feature relating to a customer call on an issue regarding “international activation & coverage” likely cannot be observed in the same day (e.g., a customer needs time to travel overseas to encounter the issue) when the collection window is one day. Consequentially, with respect to target on international charge, data collected using a one-day window size may not reveal features that appear to be relevant to the target. In this case, a feedback mechanism may be invoked to expand the data collection window size in the hope that some relevant features with a delayed occurrence may be revealed when the window size is larger. This is illustrated in FIG. 2B, where a default data collection window 270 has a size S1 and an adjusted data collection window 280 has an expanded window size S2, which is larger than S1. According to the specific situation as observed in feature management, the data collection window size may be dynamically changed to allow relevant features/feature groups to be detected, facilitating optimally managing features.

FIG. 2C is a flowchart of the exemplary application depicted in FIG. 2A, in accordance with an embodiment of the present teaching. In providing services, the network 220 operates, at 205, to deliver services to customers. During the operation of the network 220, data associated therewith is collected at 215. When the dynamic targets, specified by the target determiner 240, are received at 225, the optimal model training engine 130 generates, at 235, the target-based optimal training data with respect to the targets based on the collected data in 120-1. Using the target-based optimal training data, the optimal model training engine 130 trains, at 245, the target prediction models 140. With the trained target prediction models 140, when the target prediction unit 260 predicts, at 255, the specified targets based on real-time data collected from the network operation and sends, at 265, the predictions to the service management unit 230. Upon receiving the predictions, the service management unit 230 manages, at 275, the network operation according to the received predictions.

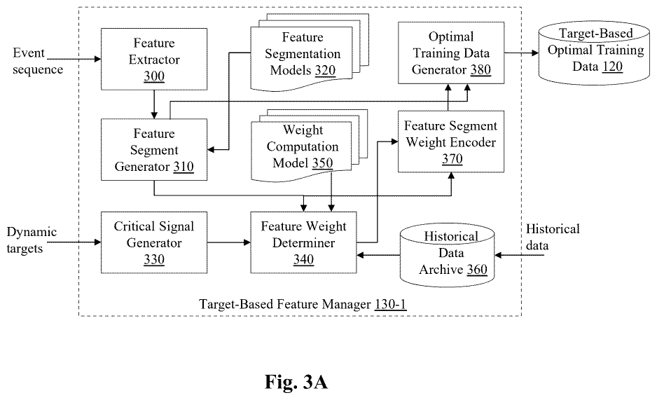

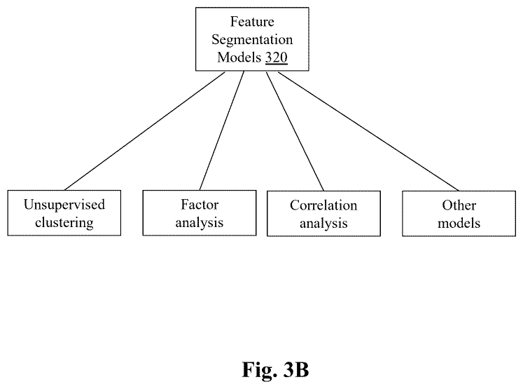

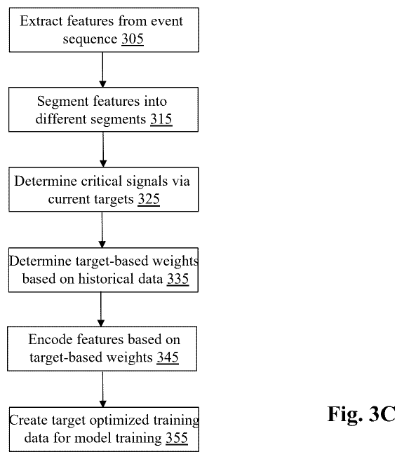

As discussed herein, the feature management with respect to given targets according to the present teaching is performed by the target-based feature manager 130-1, which evaluates the data/features with respect to specified targets to generate target-based optimal training data for training target prediction models 140. FIG. 3A depicts an exemplary high-level system diagram of the target-based feature manager 130-1, in accordance with an embodiment of the present teaching. In this illustrated embodiment, the target-based feature manager 130-1 takes the collected data 120-1 (event sequence) and specified targets as input and outputs the target-based optimal training data 120-2. In this embodiment, the target-based feature manager 130-1 comprises a feature extractor 300, a feature segment generator 310, a critical signal generator 330, a feature weight determiner 340, a feature segment weight encoder 370, and an optimal training data generator 380.

According to the present teaching, features extracted by the feature extractor 300 from the collected event sequence may be segmented, in some embodiments, into different segments of features, each of which includes features that behave in a similar manner, so that the feature relevance to each of the targets may be assessed with respect to each feature segment. The evaluation of similar behavior may be evaluated in terms of the dynamic targets specified so that how the features are grouped may depend on the targets. As illustrated in FIG. 3A, the feature segment generator 310 is provided for segmenting features into different groups based on feature segmentation models 320. FIG. 3B illustrates exemplary types of feature segmentation models 320 that may be used to group different features. As shown, such models may include unsupervised clustering models, factor analysis models, correlation analysis based models, or any other types of approaches that may be utilized to group features according to similarities. While feature relevance assessment may be performed with respect to different feature groups, in some embodiments, the relevance may also be assessed for each individual features (without grouping them) with respect to each of the targets.

To facilitate the relevance assessment, for each specified target, one or more critical signal may be generated. For example, if targets to be predicted are related to “call intents,” different critical signals may be created for “call intents,” corresponding to different intents for a call associated with services, e.g., “call intent for activation issue,” “call intent for bill explanation,” “call intent for international coverage issue,” and “call intent for bill payment issue.” Based on the critical signals corresponding to the targets, the relevance of each feature/feature segment with respect to a target may be determined based on historical knowledge represented by historical data stored in a historical data archive 360. In some embodiments, such historical data may be continuously collected during the operation of the network 220 from different network components/connections as well as from recorded service-related communications/activities between the service provider 210 and its customers. For instance, information relating to the operational states of network components and data transmission therebetween may be collected and logs on calls from customers to the service provider 210 may be categorized as to, e.g., which call at what time is about which issue and resolution thereof. Such information records the relationships of different events and consequences. For instance, the recorded historical information may reveal that during a particular night (temporal information) for system upgrade (event) in a particular service region, 75% of calls from customers in that region complained about interruption of the service.

Such historical knowledge may be utilized by the feature weight determiner 340 to assess how different features associated with a product/service attribute to different targets. For example, using the above example, the historical information on customer calls on interrupted services during system upgrade may be leveraged to determine whether features indicative of a system upgrade is relevant to predicting whether service interruption (target) will occur. In some embodiments, the level of relevance of a feature/feature segment may be represented by a metric such as a weight with respect to each critical signal corresponding to a target.

Such determined weights for features/feature groups with respect to different targets may be encoded, by the feature segment weight encoder 370, and relied upon to generate, by the optimal training data generator 380, the target-based optimal training data 120-2. There may be alternative ways to create the target-based optimal training data. In some implementations, features with low weights, i.e., low relevance, may be excluded in the optimal training data set. In other implementations, all features, including the low relevance features, may still be included in the training data but the impact of each during the training may be dictated accordingly based on the weights associated therewith to minimize the negative impact. This scheme may be appropriate when the model (e.g., artificial neural network (ANN) is constructed with a general architecture to accommodate all features. In this case, the model may be adaptively trained to derive a special model to predict some specified targets based on relevant features specified through the associated weights, although all the features are provided as input, the non-attributing features do not impose negative impact on the training process or model quality.

FIG. 3C is a flowchart of the target-based feature manager 130-1, in accordance with an embodiment of the present teaching. Upon receiving the event sequence data collected during the operation of the network, the feature extractor 300 extracts, at 305, various features from the event sequence data. The extracted features are provided to the feature segment generator 310 to segment, at 315, the features into different segments, via some feature segmentation models 320. In the meantime, based on the targets dynamically specified, the critical signal generator 330 determines, at 325, critical signals corresponding to the dynamic targets. The relevance between feature segments and different critical signals are then determined, at 335, by the feature weight determiner 340 based on the historical data in archive 360. Such weights on features obtained with respect to targets are then used by the feature segment weight encoder 370 to encode, at 345, the features so that the optimal training data generator 380 may create, at 355, the target-based optimal training data.

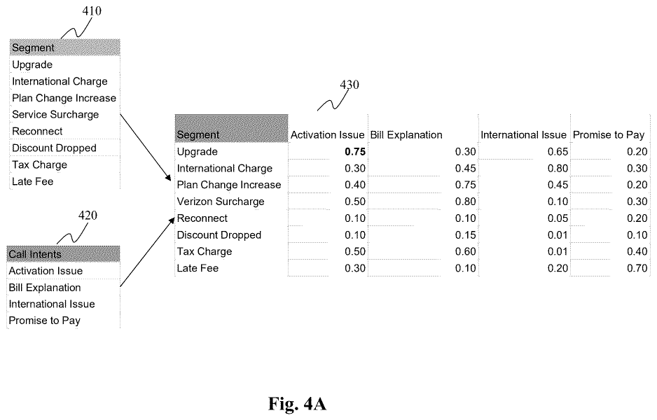

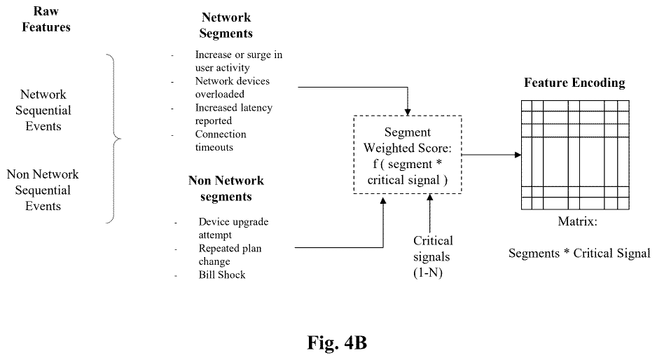

FIG. 4A shows an example use case in management some aspects of the operation of a network and an illustrated feature weight encoding result derived based on given targets, in accordance with an embodiment of the present teaching. In this illustrated example, feature segments 410 are created by, e.g., grouping features that are similar with respect to some targets. Exemplary critical signals 420 related to targets are also shown in FIG. 4A, each of which relates to some aspects of the underlying network services and is to be predicted based on prediction models trained based on target-based optimal training data, created according to the present teaching. In this example, features are grouped into several feature segments, including on upgrade, international charge, plan change increase, service surcharge, reconnect, discount dropped, tax charge, and late fee. Critical signals associated with target on call intents include activation issues, bill explanation, international issues, promise to pay, etc. Then the relevance of each feature segment in 410 to each of the critical signals in 420 is assessed and a weight for each combination of feature segment and a critical signal is computed based on the historical data from past operations. A matrix 430 encoding the target-based feature relevance with respect to targets is then generated as shown. As seen from this matrix, e.g., the feature segment on “upgrade,” the relevance to target on “activation issue” is at 0.75 which is determined based on the historical data that reveals that 75% of the customer calls during system upgrade is related to “activation issues.”

As discussed herein, using the present teaching, in certain situations (e.g., no or inadequate number of relevant features is identified), the data collection window size may be dynamically adjusted to allow more relevant features in the temporal space be collected, observed and identified, as illustrated in FIG. 2B. In some embodiments, the scope of the data collection may be expanded not only in the temporal space but also in the content space. Some aspects of products/services may be delivered online in a networked environment and some aspects of the same products/services may be delivered in a non-networked environment. For instance, a provider of wireless services, some customers may operate in a networked environment such as making a purchase, filing a complaint, asking a question, or reporting a problem via the website of the service provider. The same service provider may also have distributed physical offices to support customers and deliver certain aspects of the services in person in the offices. Data yielded from such non-networked service scenarios may also be useful so that the scope of data collections as discussed herein may also be expanded to non-networked service data, when needed, to support the feature management scheme as discussed herein.

FIG. 4B shows an exemplary scenario of the present teaching to collect event sequence data from both networked and non-networked service environment to facilitate relevance assessment of features with respect to specified targets, in accordance with an embodiment of the present teaching. As shown, features associated with products/services may be from data existing in both networked and non-networked environments. For example, as illustrated in FIG. 4B, the networked data may include the observed increase or surge in user activities, overloaded network devices, increased latency reports, and connection timeouts, etc. The non-networked data may be collected from different service offices based on interactions with customers who visited the offices, including, e.g., customers coming to the offices for device upgrades, change service plans, or complain about bills, etc. Based on data collected from both networked and non-networked environments, feature segments may be obtained as discussed herein and are used to assess the relevance thereof against different N critical signals associated with targets to determine the weights on features from both networked and non-networked environments. Such weights may then be used to derive a matrix that encodes the features against targets as discussed herein and such matrix may then be used to determine an optimal set of features to be included in the target-based optimal training data 120-2 for training the target prediction models 140, as discussed herein.

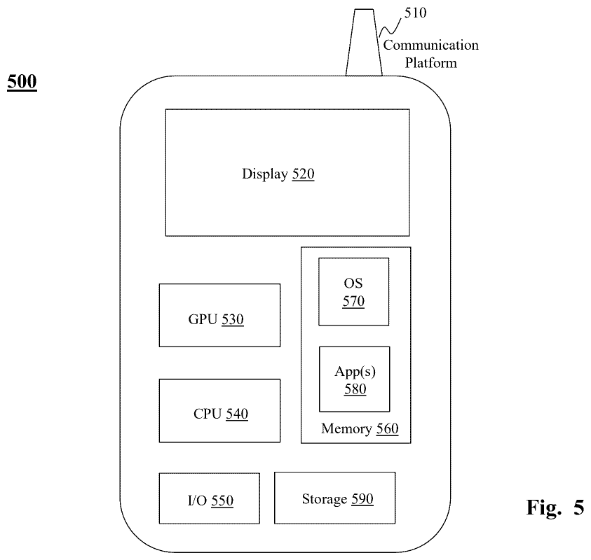

FIG. 5 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or a mobile computational unit in any other form factor. Mobile device 500 may include one or more central processing units (“CPUs”) 540, one or more graphic processing units (“GPUs”) 530, a display 520, a memory 560, a communication platform 510, such as a wireless communication module, storage 590, and one or more input/output (I/O) devices 550. Any other suitable component, including but not limited to a system bus or a controller (not shown), may also be included in the mobile device 500. As shown in FIG. 5, a mobile operating system 570 (e.g., iOS, Android, Windows Phone, etc.) and one or more applications 580 may be loaded into memory 560 from storage 590 to be executed by the CPU 540. The applications 580 may include a user interface or any other suitable mobile apps for information exchange, analytics, and management according to the present teaching on, at least partially, the mobile device 500. User interactions, if any, may be achieved via the I/O devices 550 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

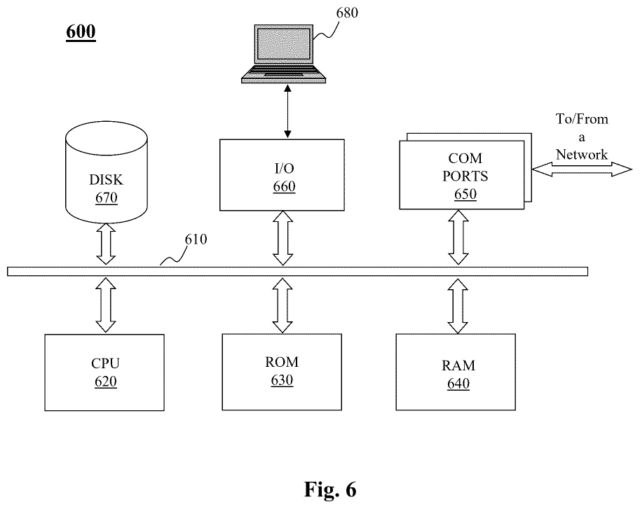

FIG. 6 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 600 may be used to implement any component or aspect of the framework as disclosed herein. For example, the information processing and analytical method and system as disclosed herein may be implemented on a computer such as computer 600, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 600, for example, includes COM ports 650 connected to and from a network connected thereto to facilitate data communications. Computer 600 also includes a central processing unit (CPU) 620, in the form of one or more processors, for executing program instructions. The exemplary computer platform includes an internal communication bus 610, program storage and data storage of different forms (e.g., disk 670, read only memory (ROM) 630, or random-access memory (RAM) 640), for various data files to be processed and/or communicated by computer 600, as well as possibly program instructions to be executed by CPU 620. Computer 600 also includes an I/O component 660, supporting input/output flows between the computer and other components therein such as user interface elements 680. Computer 600 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
collecting event sequence data characterizing states of operation of a network;
extracting features from the event sequence data;
creating, based on the features, feature segments, each of which includes one or more of the features;
receiving information specifying at least one target to be predicted based on data that is representative of corresponding at least one aspect of the operation of the network;
generating at least one critical signal corresponding to the at least one target;
determining, based on historical data representing past operational states of the network, a target-based weight indicative of relevance of each of the different feature segments with respect to each of the at least one critical signal;
encoding the feature segments based on the target-based weights thereof with respect to the at least one critical signal;
generating target-based optimal training data based on the encoded feature segments; and
training, using the target-based optimal training data, one or more prediction models for predicting the at least one target based on real-time data from the network.

2. The method of claim 1, wherein the creating the feature segments comprises:
performing analysis of the features; and
identifying the one or more of the features in each of the feature segments with respect to the at least one target according to the analysis result.

3. The method of claim 2, wherein the identifying is via unsupervised clustering of the features to group similar features with respect to each of the at least one target.

4. The method of claim 1, wherein the determining a target-based weight for each of the feature segments with respect to each of the at least one target comprises:
identifying information in the historical data relating the feature segment and the at least one target; and
with respect to each of the at least one target,
determining relevance of the feature segment with the target based on relationship in-between as revealed by the historical data, and
computing the target-based weight of the feature segment according to the relevance.

5. The method of claim 1, wherein the generating target-based optimal training data comprises:
identifying mappings in the event sequence from the feature segments to the at least one target; and
creating the target-based optimal training data based on the mappings according to the encoded feature segments.

6. The method of claim 5, wherein the creating comprises:
excluding some of the mappings where the feature segments therein are encoded with weights that satisfy a predetermined criterion.

7. The method of claim 1, further comprising:
receiving the real-time data from the network representing current operational states of the network;
predicting, using the one or more prediction models, metrics related to the at least one target based on the real-time data; and
sending the predicted metrics related to the at least one target to the network so that the network is to be managed in accordance with the predicted metrics.

8. A machine-readable and non-transitory medium having information recorded thereon, wherein the information, when read by the machine, causes the machine to perform the s=following steps:
collecting event sequence data characterizing states of operation of a network;
extracting features from the event sequence data;
creating, based on the features, feature segments, each of which includes one or more of the features;
receiving information specifying at least one target to be predicted based on data that is representative of corresponding at least one aspect of the operation of the network;
generating at least one critical signal corresponding to the at least one target;
determining, based on historical data representing past operational states of the network, a target-based weight indicative of relevance of each of the different feature segments with respect to each of the at least one critical signal;
encoding the feature segments based on the target-based weights thereof with respect to the at least one critical signal;
generating target-based optimal training data based on the encoded feature segments; and
training, using the target-based optimal training data, one or more prediction models for predicting the at least one target based on real-time data from the network.

9. The medium of claim 8, wherein the creating the feature segments comprises:
performing analysis of the features; and
identifying the one or more of the features in each of the feature segments with respect to the at least one target according to the analysis result.

10. The medium of claim 9, wherein the identifying is via unsupervised clustering of the features to group similar features with respect to each of the at least one target.

11. The medium of claim 8, wherein the determining a target-based weight for each of the feature segments with respect to each of the at least one target comprises:
identifying information in the historical data relating the feature segment and the at least one target; and
with respect to each of the at least one target,
determining relevance of the feature segment with the target based on relationship in-between as revealed by the historical data, and
computing the target-based weight of the feature segment according to the relevance.

12. The medium of claim 8, wherein the generating target-based optimal training data comprises:
identifying mappings in the event sequence from the feature segments to the at least one target; and
creating the target-based optimal training data based on the mappings according to the encoded feature segments.

13. The medium of claim 12, wherein the creating comprises:
excluding some of the mappings where the feature segments therein are encoded with weights that satisfy a predetermined criterion.

14. The medium of claim 8, wherein the information, when read by the machine, further causes the machine to perform the following steps:
receiving the real-time data from the network representing current operational states of the network;
predicting, using the one or more prediction models, metrics related to the at least one target based on the real-time data; and
sending the predicted metrics related to the at least one target to the network so that the network is to be managed in accordance with the predicted metrics.

15. A system, comprising:
a feature extractor implemented by a processor and configured for
collecting event sequence data characterizing states of operation of a network, and
extracting features from the event sequence data;
a feature segment generator implemented by a processor and configured for creating, based on the features, feature segments, each of which includes one or more of the features;
a critical signal generator implemented by a processor and configured for
receiving information specifying at least one target to be predicted based on data that is representative of corresponding at least one aspect of the operation of the network, and
generating at least one critical signal corresponding to the at least one target;
a feature weight determiner implemented by a processor and configured for determining, based on historical data representing past operational states of the network, a target-based weight indicative of relevance of each of the different feature segments with respect to each of the at least one critical signal;
a feature segment weight encoder implemented by a processor and configured for encoding the feature segments based on the target-based weights thereof with respect to the at least one critical signal;
an optimal training data generator implemented by a processor and configured for generating target-based optimal training data based on the encoded feature segments; and
a machine learning engine implemented by a processor and configured for training, using the target-based optimal training data, one or more prediction models for predicting the at least one target based on real-time data from the network.

16. The system of claim 15, wherein the creating the feature segments comprises:
performing analysis of the features; and
identifying the one or more of the features in each of the feature segments with respect to the at least one target according to the analysis result, wherein
the identifying is via unsupervised clustering of the features to group similar features with respect to each of the at least one target.

17. The system of claim 15, wherein the determining a target-based weight for each of the feature segments with respect to each of the at least one target comprises:
identifying information in the historical data relating the feature segment and the at least one target; and
with respect to each of the at least one target,
determining relevance of the feature segment with the target based on relationship in-between as revealed by the historical data, and
computing the target-based weight of the feature segment according to the relevance.

18. The system of claim 15, wherein the generating target-based optimal training data comprises:
identifying mappings in the event sequence from the feature segments to the at least one target; and
creating the target-based optimal training data based on the mappings according to the encoded feature segments.

19. The system of claim 18, wherein the creating comprises:
excluding some of the mappings where the feature segments therein are encoded with weights that satisfy a predetermined criterion.

20. The system of claim 15, further comprising a target prediction unit implemented by a processor and configured for:
receiving the real-time data from the network representing current operational states of the network;
predicting, using the one or more prediction models, metrics related to the at least one target based on the real-time data; and
sending the predicted metrics related to the at least one target to the network so that the network is to be managed in accordance with the predicted metrics.
